(19) United States
(12) Patent Application Publication
(10) Pub. No.: US 2004/0236891 A1
(43) Pub. Date: Nov. 25, 2004

(54) Processor book for building large scalable processor systems

(75) Inventors: Ravi Kumar Arimilli, Austin, TX (US); Vicente Enrique Chung, Austin, TX (US); Jody Bern Joyner, Austin, TX (US); Jerry Don Lewis, Round Rock, TX (US)

Correspondence Address: BRACEWELL & PATTERSON, L.L.P., P.O. BOX 969, AUSTIN, TX, 78767-0969, US

(73) Assignee: International Business Machines Corporation, Armonk, NY (US)

(21) Appl. No.: 10/425,420

(22) Filed: Apr. 28, 2003

(51) Int. Cl. G06F 13/36

(52) U.S. Cl. 710/306

(57) ABSTRACT

A method and system for providing a multiprocessor processor book that is utilized as a building block for a large scale data processing system. Two 4-way multi-chip modules (MCM) are utilized to create the processor book. The first and second MCMs are configured with normal wiring among their respective processors. An additional wiring is provided that links external buses of each chip of the first MCM with buses of a corresponding chip of the second MCM and vice versa. The additional wiring enables each processor of the first MCM substantially direct access to the distributed memory components of the next MCM with no affinity. The processor book is plugged into a processor rack configured to receive multiple processor books that together make up the large scale data processing system.

### CROSS REFERENCE TO RELATED APPLICATIONS

The present application shares specification text and figures with the following co-pending application, filed concurrently with the present application: application Ser. No. 09/______ (Attorney Docket Number AUS920020206US1) “Data Processing System Having Novel Interconnect For Supporting Both Technical and Commercial Workloads.” The content of the co-pending application is incorporated herein by reference.

### BACKGROUND OF THE INVENTION

1. Technical Field

The present invention relates generally to data processing systems and in particular to multi-processor data processing systems. Still more particularly, the present invention relates to a method and system for efficiently interconnecting multiple processors to provide a building block for a large scale multi-processor system.

2. Description of the Related Art

The evolution of data processing systems for use in commercial applications has occurred at a very rapid pace. This development began with the design and utilization of single processor systems and has evolved to design and utilization of more complex multiple processor systems (MPs). Most of the development has been driven by the increasing need in the industry for greater processing power and faster data operations.

Technical and commercial servers are two examples of systems that have benefited from the additional processing power and faster overall data operations. These systems are typically designed with distributed memory systems, with each processor having direct access to an affiliated memory block, or very large caching mechanisms with minimal memory affinity.

FIGS. 1A-1D illustrate the progression from a single processor system to more and more complex data processing systems utilizing a conventional processor-memory configuration as a building block. As illustrated by FIG. 1A, conventional single processor-chip system 100 comprises a single processor 101 and memory 105 interconnected by a pair of buses. Each bus provides a set bandwidth (i.e., number of bytes) for communication between the processor chip and memory 105. In FIG. 1A, processor 101 is connected to memory 105 in what is referred to as a “1-way” configuration via 8-byte data input bus and 16-byte data output bus. Memory 105 provides the instructions and data utilized by processor 101 during processing. There are several alternative implementations for buses including tri-state buses and uni-directional/bi-directional buses.

Conventional single processor-chip system 100 is utilized as a building block for subsequent generations of processing systems comprising multiple processor chips coupled together via two inter-processor buses. FIG. 1B illustrates a 2-way system with inter-processor buses 103 connecting processors 101 of each chip.

As the number of processor chips to be connected together increased (due to demands for systems with greater amounts of processing power), a hierarchical switch based topology, as exemplified by switches, SW 121, was implemented to support the connectivity among the processor chips. FIGS. 1C and 1D illustrate a four-way and an eight-way system, respectively, with the processor chips 101 coupled to each of the other processor chips via a hierarchical switch topology. The 4-way system of FIG. 1C requires only a two level hierarchy of wire connections, with the top level comprising 2 sets of two interconnected processor chips.

FIG. 1D illustrates the hierarchical switch-based topology with an 8-way system in which there are three levels or wire connections. As can be seen with the hierarchical switch topology, the processors are each directly connected to only their associated memory block and to a single processor at the highest level of the hierarchical switch (i.e., the processors are not fully interconnect). Similarly to a 1-way system, the conventional 2-way, 4-way and 8-way systems thus display one-to-one memory affinity. That is, each processor has direct access to only connected memory block. One-to-one memory affinity limits the larger systems having multiple processors from full utilization of the available memory resources/bandwidth within the overall system.

A careful analysis of the effective scaling of each system as the number of processors is increased reveals that the growth in terms of the memory bandwidth and memory affinity does not scale linearly when the number of processors increases. Each increase in the number of processor chips results in a non-linear increase in the amount of bus bandwidth required to support the fully-interconnected configuration. Notably, the number and bandwidth of buses increases faster than the number of processors. A larger byte-total of buses is needed to support the high bandwidth memory usage without affinity. As the number of processors increases to provide larger systems, e.g., an 8-way system, the byte total required for the buses become extremely large. Unfortunately, the small surface area available for providing buses off the chip severely limits the total width or number of buses and hence the actual bandwidth that can be directly supported by each chip.

As can be seen, because of the relatively small surface area (or perimeter) available on the processor chips for allocation to buses for external connection, each increase in the number of processors in the processor systems becomes more and more restrictive and impractical. However, the need for even more complex systems with larger number of processors still exists. Providing these systems with the above hierarchical switch is extremely costly and inefficient.

Thus, several disadvantages of utilizing the above switch-topology are recognized, including: greater memory latency; reduced bandwidth; increased cost due to more wires and switches, logic and other external components; and increased power requirement and physical real estate to build the system.

The present invention recognizes that it would be desirable to provide a multi-processor system (MP) configured as an N-way system that scales to provide larger systems without requiring more buses on the chip than is practical. A MP that may be utilized as a building block for a larger scalable processing system without significant reconfiguration would be a welcomed improvement. These and other benefits are provided by the invention described herein.

### SUMMARY OF THE INVENTION

Disclosed is a method and system for providing a processor book that is configured with multiple processors and coupled distributed memory. Two 4-chip multi-chip modules (MCM) are utilized as the building blocks for creating the processor book. The first and second MCMs are configured with processor-to-processor wiring interconnecting their respective processors. Additional wiring is provided that links external pins of each chip of the first MCM with a corresponding chip of the second MCM and vice versa. The additional wire connections provide each processor of the first MCM access to the processing power and the distributed memory components of the second MCM, and the memory components operate with no affinity to any processor, and vice versa.

Routing logic is provided within each chip to control the routing of data to and from each chip from and to the other chips in the processor book. In one embodiment, the routing logic includes a software settable logic component for later configuring the processor book for operation as either a commercial workload processor book or a technical workload processor book.

The total number of buses required to complete the connections is significantly less than the number required with a conventional 8-way system that provides direct processor-to-processor connections, and the costs (additional logic, etc.) associated with a hierarchical, switch-based system is not realized.

With the implementation of the processor book as a building block, a large scale system may be provided comprising a system rack with several receptors for connecting multiple processor books. The system rack is wired so that each processor book plugged into one of the receptors becomes a part of a larger system of processors sharing distributed memory. The routing logic includes the logic required to support the external routing of communication from one processor book to another processor book coupled to the system rack.

### BRIEF DESCRIPTION OF THE DRAWINGS

The novel features believed characteristic of the invention are set forth in the appended claims. The invention itself, however, as well as a preferred mode of use, further objectives, and advantages thereof, will best be understood by reference to the following detailed description of an illustrative embodiment when read in conjunction with the accompanying drawings, wherein:

FIGS. 1A-1D are block diagrams illustrating the development of conventional N-way processing systems according to the prior art;

FIG. 2A is a block diagram illustration of a 4-way multi-chip module (MCM) utilized as a building block of a processor book according to one embodiment of the invention;

FIGS. 2B and 2C are two illustrations of 8-way processor books designed by interconnecting two MCMs of FIG. 2A and which may be utilized as either a commercial workload processor book or a technical workload processor book in accordance with one implementation of the invention;

FIGS. 3A and 3B depict N×8-way SMPs comprising N of the 8-way processor books of FIG. 2B interconnected via MCM external connector buses (ECBs) on a system rack to provide a commercial workload server according to one implementation of the invention; and

FIG. 3C is a block diagram illustrating connectivity mechanism for each 8-way processor book to the system rack of FIGS. 3A and 3B in accordance with one embodiment of the invention.

The above as well as additional objectives, features, and advantages of the present invention will become apparent in the following detailed written description.

### DETAILED DESCRIPTION OF AN ILLUSTRATIVE EMBODIMENT

The present invention introduces a novel processor book comprised of two interconnected multi-chip modules (MCM). The processor book is in turned designed to be connected to other processor books on a system rack to provide much larger commercial or technical systems. Also, unlike the prior art multi-chip configurations, routing logic within the processors of the processor book is provided to enable the processors to display full memory capacity enabling greater use of the available memory bandwidth.

The invention is thus implemented with processor configurations in which each processor was capable of fully consuming the distributed memory without any memory affinity (i.e., a fully-aggregate model). One way in which this is enabled involves re-configuring the 2-way systems with 16-byte buses connecting the processors. With the larger buses, each of the processors in the 2-way and larger systems are allowed to fully access the memory block coupled to any one of the other processors. This fully aggregate model is then utilized to design the 4-way MCMs having four processor chips in a fully-interconnected configuration.

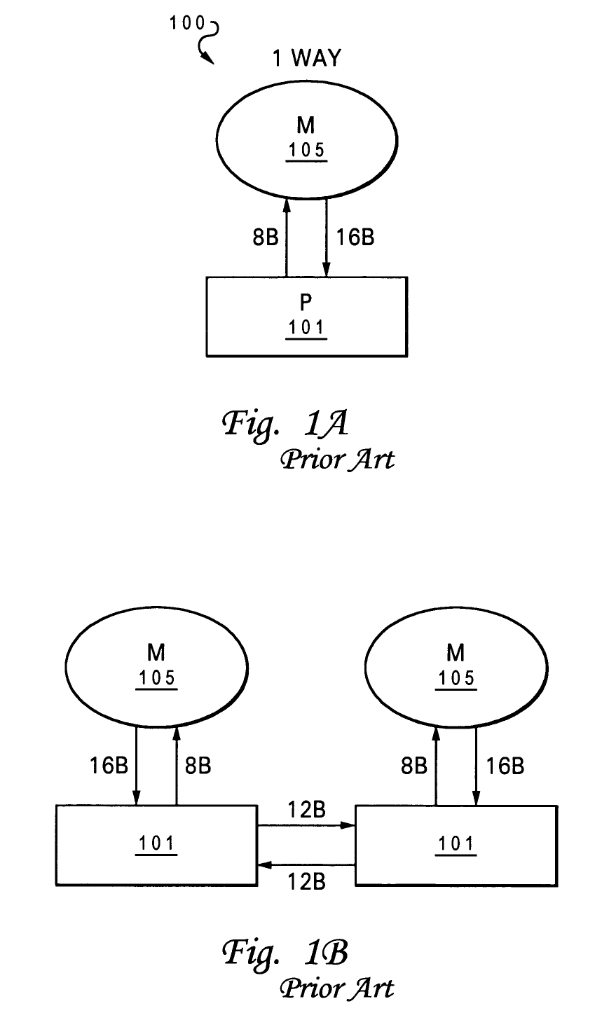

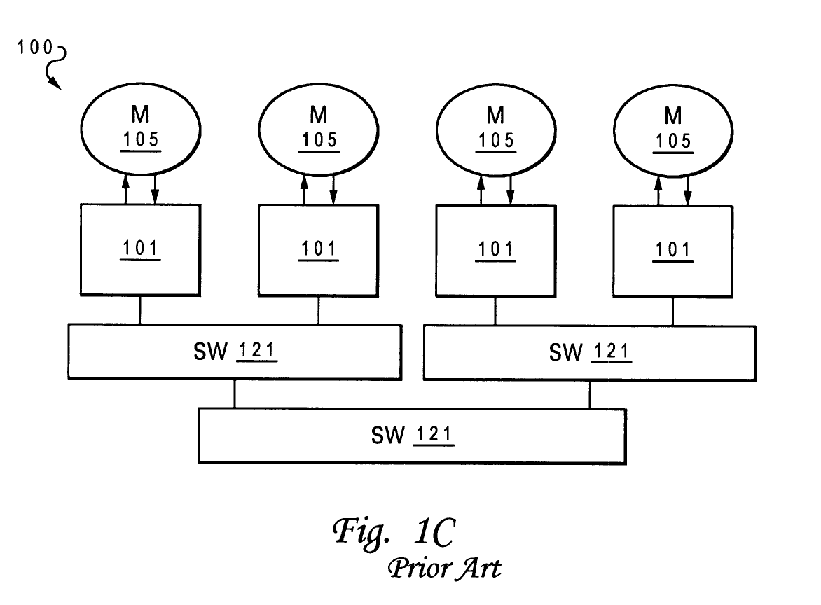

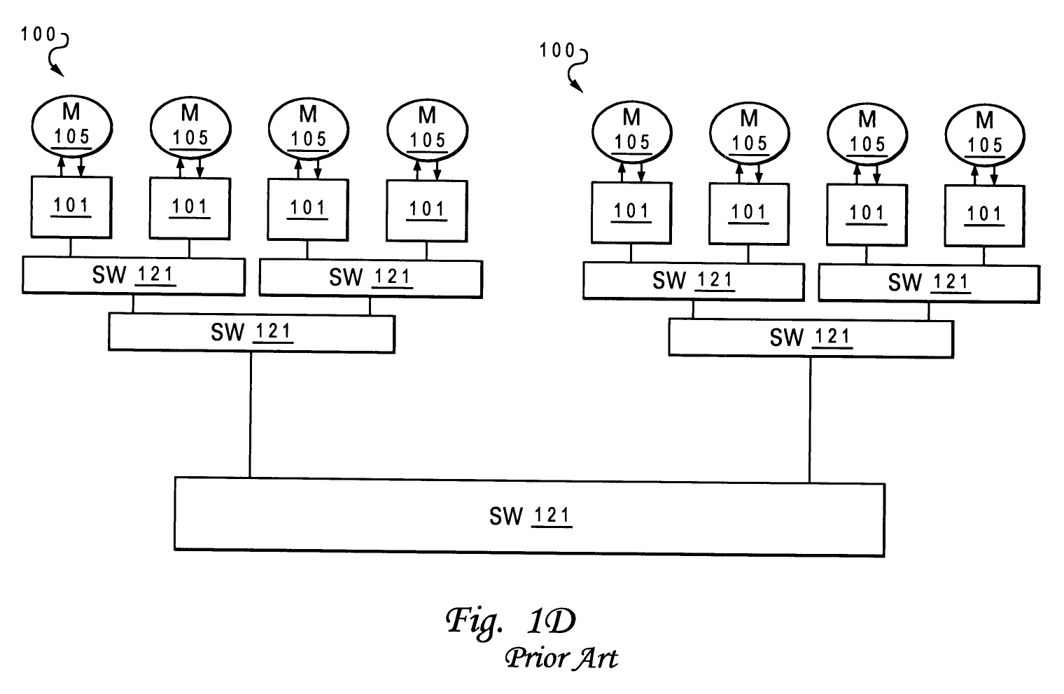

In an MCM, two or more processor chips each comprising one or more processors are interconnected with buses having a particular bandwidth. Thus, for example, a four-processor multi-chip module (MCM) may be designed by interconnecting 4 single-processor chips with 16-byte buses. The MCM provides higher overall frequency as well as other advantages over other 4-way configurations (such as illustrated in FIG. 1C). In particular, the MCM configuration provides increased performance for commercial workloads over the traditional switch-based 4-way configuration.

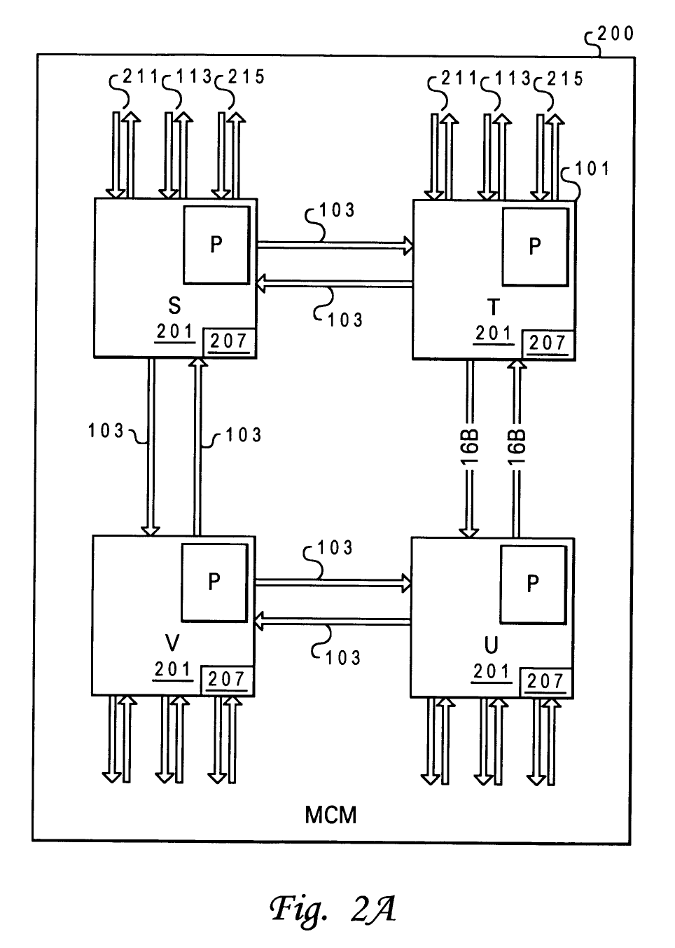

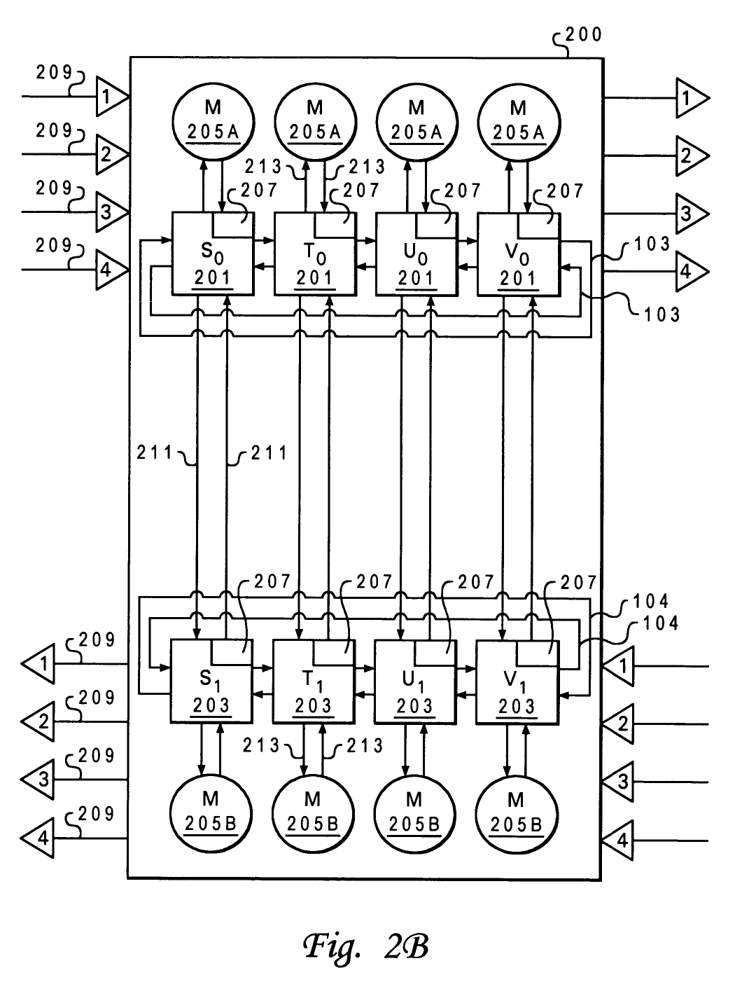

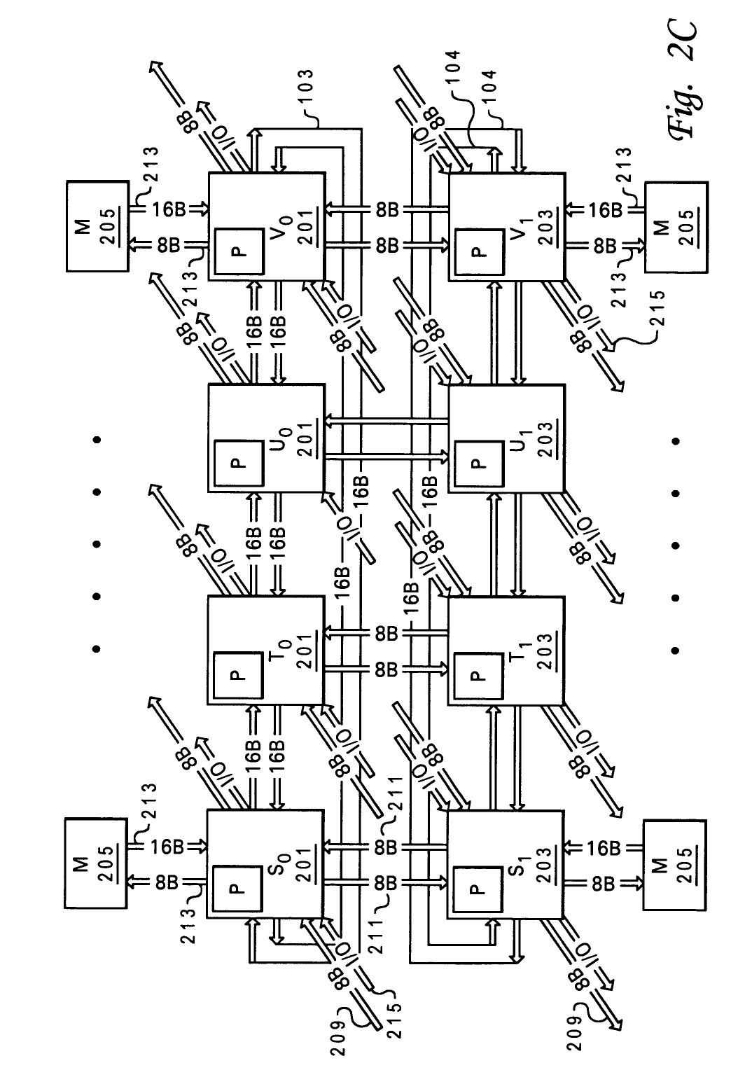

FIG. 2A illustrates a 4-processor MCM (also referred to as a 4-way multiprocessor (MP)). As shown, MCM 200 includes four single-processor chips 201 interconnected by MCM bus 103. Each processor chip 201 comprises MCM logic 207, described below. Processor chips 201 of MCM 200 are interconnected to and communicate with each other via pairs of 16-byte MCM buses 103, with each pair of MCM buses 103 including a 16-byte MCM input bus and a 16-byte MCM output bus. According to FIG. 2A, each processor chip is directly coupled to two other processor chips on MCM 100.

Each chip 201 contains internal MCM routing logic 207 that manages the inter-chip data transfers on the various buses. MCM routing logic 207 controls both routing to components within MCM 200 and routing to components connected externally to MCM 100. MCM routing logic 207 reads the destination address contained within the data component being routed and selects the appropriate bus on which to route the data component. For example, communication (collectively described herein as data communication, although instructions may also be routed between processor chips) from a processor on chip S to a processor of either of the adjacent processor chips, T or V, are sent by MCM routing logic 207 of chip S on the MCM buses 103 directly coupling the two chips. However, when communication is desired from a processor on chip S to one on chip U (i.e., the processor chip that is logically farthest away and not directly coupled to S), MCM routing logic 207 sends the communication to the processor on chip U via a hop across one of the two adjacent processor chips, T or V. Routing at each stage of the hop is controlled by MCM routing logic 207 on the particular chip. Each communication path between non-adjacent processors has a higher latency because of the extra hop that is required.

Each chip within MCM 200 connects to other external components including memory (not shown) and I/O devices (not shown) via additional buses connected directly to each die. The number of additional buses available for connecting external components (i.e., components other than the other processors) is a function of the size of the chip. Typically, only a fixed number of buses can be connected to each die, and thus the connectivity of each chip is limited by the fixed number of buses. Thus, although the 4-chip MCM has been efficiently designed, the 8-processor or 8-chip system of FIG. 1D with hierarchical switch interconnect does not scale in performance or costs.

The present invention is described below with specific reference to an 8-way SMP book comprised of two interconnected 4-way MCMs (i.e., two MCMs including four chips having a single processor per die) similar to MCMs of FIG. 2A. Those skilled in the art appreciate that the features described herein and specific references to an 8-way SMP book are meant solely for illustrative purpose and should not be construed as limiting on the invention, which may equally apply to more complex systems with multiple processors per die or more chips per SMP book.

The invention provides a building block for realizing a large scale processing system with a large number of processing components, large supporting memory, and interconnectivity that does not require scaling beyond that which is practical given the size of the processor chips. Specifically, the invention addresses the need for more complex systems to handle commercial and technical workloads by providing individual 8-way data processing systems (referred to hereinafter as processor books) and then utilizing these processor books as a building block to provide more complex MPs.

FIGS. 2B and 2C illustrate two configurations of the 8-way SMP, which is referred to as a processor book (i.e., a mother board hosting two interconnected 4-processor MCMs) according to the invention. As shown, processor book 200 comprises a first MCM (i.e., processor chips 201 and related memory components 205A) and a second MCM (processor chips 203 and related memory components 205B). Both the first and second MCMs are 4-way MCMs similar to MCM 200 of FIG. 2A.

As illustrated in FIG. 2C, in addition to 8-byte MCM chip-to-chip buses 103, which directly interconnects the processors, processor chips 201 of MCM 200 includes the following additional buses: two 8-byte MCM expansion control buses (ECB) 209; two 8-byte MCM-to-MCM buses 211; a pair of memory buses 213 including 8-byte memory input and 16-byte memory output buses; and two 8-byte I/O buses 215.

Each chip of processor book 200 also comprises MCM routing logic 207, which also manages the routing of communication between the first MCM and the second MCM. MCM routing logic 207 controls the routing that occurs on all of the external buses of the MCMs including the MCM-to-MCM buses 211 and MCM ECB 209. As shown, a pair of MCM-to-MCM buses 211 run to and from each processor chip of the first MCM from and to the corresponding processor chip of the second MCM (e.g. S0-S1, T0-T1, etc.).

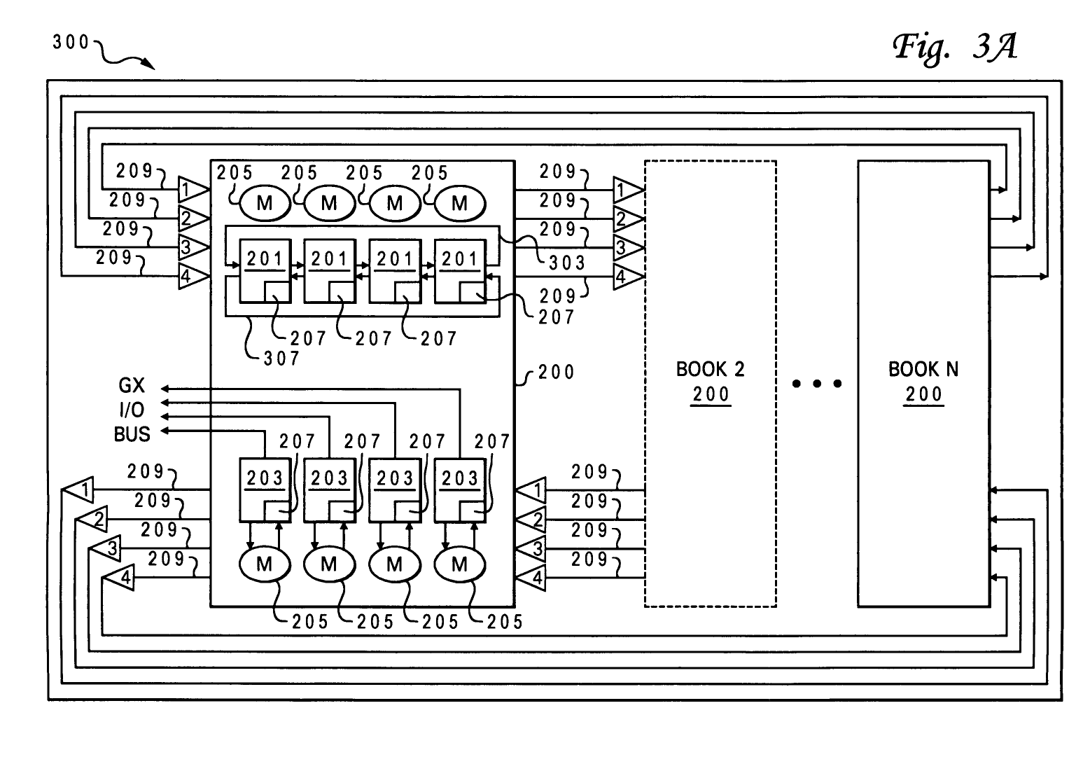

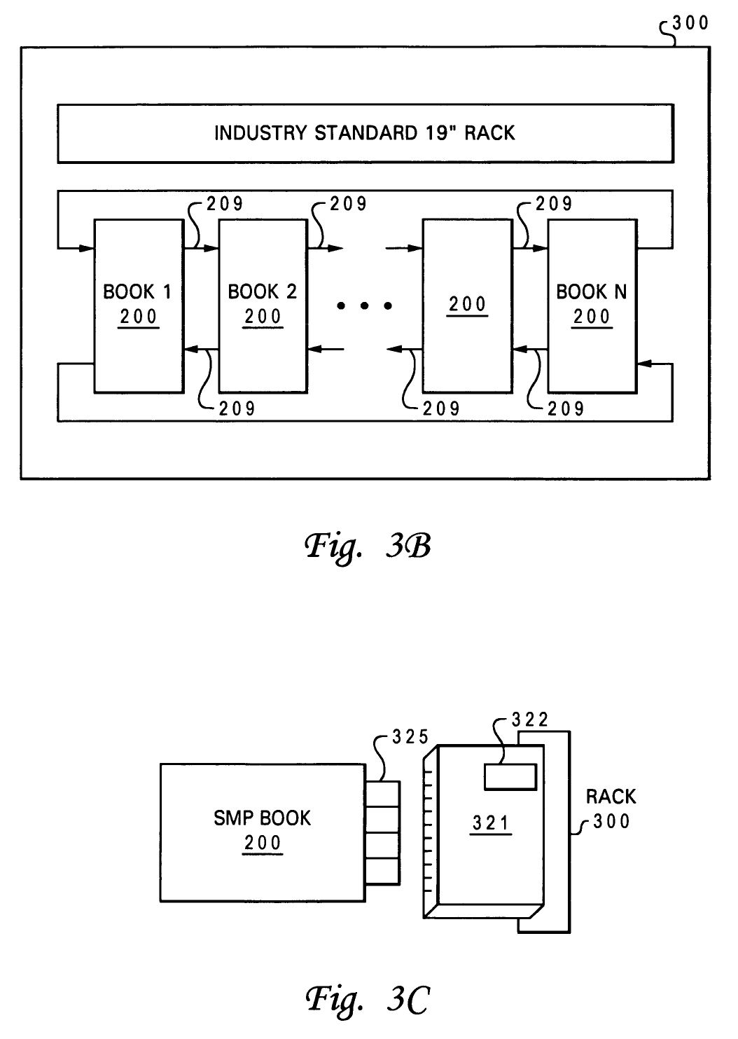

Both FIGS. 2B and 2C illustrate the interconnection between the processors of the first MCM and the second MCM within processor book 200 including the MCM expansion buses 209. Processor chips 201, 203 of each MCM are interconnected to each other via 16-byte chip-to-chip buses 103, with each chip having a 16-byte input bus and a 16-byte output bus from both neighboring processor chips on the respective MCM. Connected to the individual processor chips 201, 203 is distributed memory 205, each block of which is connected to a respective processor chip via a pair of buses 213. In one embodiment pair of buses comprise 8-byte data input bus and a 16-byte data output bus 213. Also shown are a series of MCM ECBs 209, which provide processor chips 201, 203 with connectivity to external components as shown in FIG. 3. According to the invention, in the commercial MPs, MCM ECBs 209 are utilized to interconnect a processor book to other external processor books, such as another 8-way SMP.

During processor book operation, communication from a first MCM to the second MCM always requires at least one transfer over an 8-byte bus. For example, a communication from S0 to S1 is routed directly on MCM bus 211. Notably, a communication from S0 to U1 requires two intermediate hops (i.e., S0-T0-U0) along the MCM 16-byte bus before being transmitted across the processor book to U1 on the 8-byte MCM bus. Alternatively, the same communication may be routed via the path S0-S1-T1-U1. Determination of the exact route to take is made by MCM routing logic 207, based on current usage on the various paths, etc. Irrespective of which path is taken, the communication takes two hops before arriving at the destination.

Multiple 8-way processing systems designed according to the configuration shown in FIGS. 2B and 2C are often connected together in the manner illustrated by FIGS. 3A and 3B to create a large scale commercial processing system (i.e., a multiprocessor system designed with a large number of processors each having the functional characteristics required to handle commercial data workloads). Typically, a commercial workload requires a processing system that includes a large amount of processing resources, and cache sites, but does not require large amounts of memory bandwidth or data transfer efficiency. For commercial processing, the memory latency of inter-chip communications (due to the additional hops) is acceptable. However, these hops would not be optimal to build an efficient technical SMP as they result in an inefficient utilization of memory. As a result, the above processor book configuration is more optimized to handle commercial workloads, which are not less sensitive to these deficiencies as described below.

FIG. 3A illustrates a sequence of processor books 200 wired together to form a commercial SMP 300 (i.e., a SMP designed to process commercial workloads) according to one embodiment of the invention. In the commercial arena, large scale data processing systems usually require a large amount of processing capability. In order to provide this processing capability, multiple processor books 200 are wired together using the MCM ECBs 209 of the processor chips. These buses are shown running from the first and second MCMs of processor books 200. In this manner, an N×8-way (e.g., 32w, 48w, 64w, etc.) commercial SMP system is provided, where N is a positive integer.

FIG. 3B illustrates a similar configuration as FIG. 3A with the processors assembled on system rack 300. System rack 300 comprises a passive backplane on which multiple backplane connectors (illustrated in FIG. 3C) are provided for inter-connecting multiple processor books simultaneously. FIG. 3C illustrates one example of backplane connector 321 of system rack 300. Also shown is sample processor book 200, which includes plug-in connector 325 that “plugs” into backplane connector 321 of system rack 300.

Plug-in connector 325 includes pins, which are the terminating wires of MCM ECBs 209 of processor book 200. Thus, according to the 8-processor configuration of processor book 200, plug-in connector 325 includes a separate connector pin for each of the 8 output ECBs and each of the 8 input ECBs. Manufacture of system rack 300 is completed separately from that of processor books 200 and thus different manufacturing techniques and/or designs may be utilized to enable the connectivity of processor book 200 to processor system 300 and ultimately to each other processor book.

The passive backplane of system rack 300 includes wiring that is meshed into the base material and interconnects each backplane connector 321 on processor rack 300 similarly to the connectivity illustrated in FIG. 3A. For commercial applications, when processor book 200 is plugged into backplane connector 321 of processor rack 300 via plug-in connector 325, the MCM ECBs 209 of processor book 200 connect to the MCM ECBs 209 of the adjacent processor books on the rack similarly to the illustration of FIGS. 3A and 3B. Thus, use of system rack 300 enables the building of larger and larger commercial SMPs scaled according to the size of system rack 300 and the number of processor books connected thereto.

Communication among processor books is controlled by logic 207 located on each processor book. Logic 207 provides a routing protocol to allow data from one book to be passed to another adjacent book. When data are transferred from a processor on chip U0 of a first processor book to processor S0 of another processor book, the transfer within the processor book (U0-T0-S0 or U0-V0-S0) is controlled by internal routing features of MCM routing logic 207 on 16-byte MCM bus 203, while the transfer across processor books (S0-S0) is controlled by external routing features of MCM routing logic 207 on 8-byte MCM ECB 209.

Additionally, with the re-configured/re-wired processor book, an 8-way SMP is provided across all of the memory without requiring or exhibiting any memory affinity. The increased bandwidth for data transmission enables each memory subsystem to run at substantially 100% of capacity since required data transfer does not have to wait on other processes before gaining access to the data buses. Thus, higher memory bandwidth and lower memory latency are achieved from the 8-way processor book originally designed for commercial workloads so that the processor book is optimized to support a technical workload.

Although the invention has been described with reference to specific embodiments, this description should not be construed in a limiting sense. Various modifications of the disclosed embodiments, as well as alternative embodiments of the invention, will become apparent to persons skilled in the art upon reference to the description of the invention. For example, although each chip is illustrated and described as having a single ECB output and a single ECB input, other bus counts fall within the scope of the invention (e.g., a separate ECB bus for each processor). Also, although described as an 8-way processor book, the invention may be implemented with different size processor books. For example, a 16-way processor book comprising two processors per chip in the same MCM-to-MCM configuration may be utilized. It is therefore contemplated that such modifications can be made without departing from the spirit or scope of the present invention as defined in the appended claims.

What is claimed is:

1. A processor book comprising:
a first processor chip module including a first plurality of processor chips interconnected by a first set of intra-module buses that are internal to said first processor chip module, said first plurality of processor chips including at least processor chips S₀ and T₀;
a second processor chip module including a second plurality of processor chips interconnected by a second set of intra-module buses that are internal to said second processor chip module, said second plurality of processor chips including processor chips S₁ and T₁;
a third set of buses external to said first processor chip module and said second processor chip module and which respectively connect each processor chip of the first processor chip module to a corresponding processor chip of the second processor chip module, wherein S₀ connects to S₁, and T₀, connects to T₁; and
means for providing each of said processor chips with an external connection point by way of an external bus, said means including a plurality of external routing buses each connected to a respective processor chip in said processor book.

2. The processor book of claim 1, further comprising:
a distributed memory with individual memory components coupled to each of said processor chips of said first processor chip modules and said second processor chip modules; and
wherein said first, second, and third set of buses provide bus bandwidth to enable access to each of said individual memory components by each processor within said processor chips without memory affinity.

3. The processor book of claim 1, wherein further:
said fourth set of buses provide connections to another group of similarly configured processor chip modules.

4. The processor book of claim 2, wherein further, said fourth set of buses extend from said processor chips into a connector comprising pins representing each bus within said fourth set of buses.

5. The processor book of claim 1, wherein said first set of buses and said second set of buses are 16 byte buses and said third set of buses are 8 byte buses.

6. The processor book of claim 5, wherein each memory component is coupled to its respective processor chip via an 8-byte data input bus and a 16-byte data output bus.

7. The processor book of claim 1, further comprising a fifth set of input/output (I/O) buses each coupled to one of said processor chips and which provides means for receiving external inputs and sending outputs from a respective processor chip.

8. The processor book of claim 1, further comprising routing logic associated with each one of said processor chips for directing data transfer within said processor book from one processor chip to another processor chip including from said first MCM to said second MCM and from said second MCM to said first MCM.

9. A data processing system comprising:
a processor book with an external connection point, said processor book including:
a first processor chip module including a first plurality of processor chips interconnected by a first set of intra-module buses that are internal to said first processor chip module, said first plurality of processor chips including at least processor chips S₀ and T₀;
a second processor chip module including a second plurality of processor chips interconnected by a second set of intra-module buses that are internal to said second processor chip module, said second plurality of processor chips including processor chips S₁ and T₁;
a third set of buses external to said first processor chip module and said second processor chip module and which interconnect each of processor chips S₀ andT₀, U₀, and V₀ to a respective one of processor chips S₁, and T₁;
a fourth set of buses extending externally from said processor book, said fourth set of buses including a plurality of external routing buses each connected to a respective processor chip in said processor book, wherein said external routing buses provide a connection point for components external to the processor book; and
components external to said processor book that are coupled to said processor book via said external connection point.

10. The data processing system of claim 9, further comprising:
a distributed memory with individual memory components coupled to each of said processor chips of said first processor chip modules and said second processor chip modules; and
wherein said first, second, and third set of buses provide bus bandwidth to enable access to each of said individual memory components by each processor within said processor chips without memory affinity.

11. The data processing system of claim 9, wherein further:
said fourth set of buses provide connection to another group of similarly configured processor chip modules.

12. The data processing system of claim 10, wherein further, said fourth set of buses extend from said processor chips into a connector comprising pins representing each bus within said fourth set of buses.

13. The data processing system of claim 9, wherein said first set of buses and said second set of buses are 16 byte buses and said third set of buses are 8 byte buses.

14. The data processing system of claim 13, wherein each memory component is coupled to its respective processor chip via an 8-byte data input bus and a 16-byte data output bus.

15. The data processing system of claim 9, further comprising a fifth set of input/output (I/O) buses each coupled to one of said processor chips and provides means for receiving external inputs and sending outputs from a respective processor chip.

16. The data processing system of claim 1, further comprising routing logic associated with each one of said processor chips for directing data transfer within said processor book from one processor chip to another processor chip including from said first MCM to said second MCM and from said second MCM to said first MCM.

17. A data processing system comprising:
a processor rack including a backplane with a plurality of connectors for receiving a plug-in head of processor books, wherein each connector of said plurality of connectors are wired sequentially to each other; and
a first processor book having said plug-in head coupled to a first one of said plurality of connectors, said processor book comprising:
a first processor chip module including a first plurality of processor chips interconnected by a first set of intra-module buses that are internal to said first processor chip module, said first plurality of processor chips including at least processor chips S₀ and T₀;
a second processor chip module including a second plurality of processor chips interconnected by a second set of intra-module buses that are internal to said second processor chip module, said second plurality of processor chips including processor chips S₁ and T₁;
a third set of buses external to said first processor chip module and said second processor chip module and which interconnect each of processor chips S₀ andT₀, U₀, and V₀ to a respective one of processor chips S₁, and T₁; and
a fourth set of buses extending externally from said processor book, said fourth set of buses including a plurality of external routing buses each connected to a respective processor chip in said processor book, wherein said external routing buses provide a connection point for components external to the processor book.

18. The data processing system of claim 17, said processor book further comprising:
a distributed memory with individual memory components coupled to each of said processor chips of said first processor chip modules and said second processor chip modules; and
wherein said first, second, and third set of buses provide bus bandwidth to enable access to each of said individual memory components by each processor within said processor chips without memory affinity.

19. The data processing system of claim 17, said processor book further comprising:
a second processor book also coupled to a second one of said plurality of connectors, said second processor book similarly configured to said first processor book and interconnects with said first processor book via a wire connection between said first connector and said second connector on said processor rack.

20. The data processing system of claim 18, wherein further, said fourth set of buses extend from said first processor chip into said plug-in head and terminate as pin connectors within said plug-in head.

21. The data processing system of claim 19, further comprising routing logic on said first processor book for selecting routing paths for transmission of data and communication both on said first processor book and off said first processor book to said second processor book.

22. The data processing system of claim 22, further comprising:
wiring means for completing a connection from one connector to another when said connector does not contain a processor book coupled thereto so that a complete connection path is always provided within said processor rack.
